(19) United States
(12) Patent Application Publication
(10) Pub. No.: US 2026/0233123 A1
(43) Pub. Date: Aug. 13, 2026

(54) LC-MS METHOD FOR ANALYZING CARBON CAPTURE SOLVENTS AND THEIR DEGRADATION PRODUCTS

(71) Applicant: SAUDI ARABIAN OIL COMPANY, Dhahran (SA)

(72) Inventors: Chanel Sitto, West Bloomfield, MI (US); Alexander Voice, Detroit, MI (US); Katherine Hull, Houston, TX (US); Linh Mai, Houston, TX (US)

(73) Assignee: ARAMCO SERVICES COMPANY, Houston, TX (US)

(21) Appl. No.: 19/048,190

(22) Filed: Feb. 7, 2025

(51) Int. Cl. B01D 15/30; B01D 15/16; B01D 53/14; B01D 53/34; B01D 53/62; B01D 53/78; G01N 30/02; G01N 30/34; G01N 30/72

(52) U.S. Cl. CPC B01D 15/305; B01D 15/166; B01D 53/1406; B01D 53/1475; B01D 53/346; B01D 53/62; B01D 53/78; G01N 30/34; G01N 30/7233; B01D 2252/20484; B01D 2257/504; G01N 2030/027

(57) ABSTRACT

A method includes providing a sample including a carbon capture solvent and degradation products produced by a carbon capture operation. The method includes forming a mobile phase, where the mobile phase is buffered to a pH of at least 9; and diluting the sample, where a diluent used is buffered to a pH of at least 9, and where the diluent used has the same composition as the mobile phase at the start of the method. The method includes obtaining fractions of the solution by separating the sample with a hydrophilic interaction liquid chromatography (HILIC) system, where the HILIC system includes a stationary phase and the mobile phase; and measuring substances in the fractions with a detector. The method includes identifying the carbon capture solvent and degradation products based on a response of the detector as compared to the response of the detector from a set of standards.

### BACKGROUND

Effective carbon capture solvent management encompasses several key considerations. First, maintaining solvent stability is needed to ensure consistent performance during carbon capture operations. Solvents may undergo degradation due to factors such as temperature fluctuations, exposure to impurities, chemical reactions, and oxidative stress. This degradation may lead to decreased carbon capture capacity, increased corrosion, and reduced solvent lifespan. Furthermore, the degradation products when released into the environment, may be toxic or lead to adverse secondary environmental impacts.

To address these challenges, solvent management strategies for carbon capture operations may involve monitoring key performance indicators such as solvent degradation rate, solvent loss, and solvent viscosity. Additionally, maintaining optimal operating conditions, including temperature, pressure, and solvent flow rate may help minimize degradation and enhance overall system performance. Regular monitoring, periodic solvent analysis, and proactive maintenance are needed to extend solvent life and maximize the efficiency of carbon capture operations while ensuring proper management and mitigating degradation products.

Analyzing degradation products resulting from carbon capture operations necessitates the application of sophisticated analytical methods. Chromatography techniques, such as gas chromatography (GC) and liquid chromatography (LC), may be employed to separate and identify compounds present in the solvent. Spectroscopy techniques, including infrared (IR) spectroscopy and nuclear magnetic resonance (NMR) spectroscopy, offer valuable insights into the chemical structure and composition of degradation products. Mass spectrometry (MS) plays a critical role in identifying and quantifying specific degradation products by assessing the mass-to-charge ratio of ionized molecules. Advanced mass spectrometry techniques like liquid chromatography-mass spectrometry (LC-MS) and gas chromatography-mass spectrometry (GC-MS) provide enhanced sensitivity and specificity by resolving complex mixtures of components in a time domain, enabling the detection of trace levels of organic degradation products. These products may be chemically similar to the carbon capture solvent, while being present at concentrations several orders of magnitude less than the “parent” solvents from which they were formed.

Carbon capture solvent management and the analytical methods used for analyzing degradation products are needed for the success of carbon capture technologies. By implementing effective solvent management strategies and employing robust analytical techniques, it is possible to optimize the performance and longevity of carbon capture solvents. Therefore, there exists a need for analytical methods, such as LC-MS, that monitor carbon capture operations and effectively identify carbon capture solvents and their degradation products.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method. The method may include providing a sample of a solution produced by a carbon capture operation, where the solution includes a carbon capture solvent and degradation products of the carbon capture solvent produced by the carbon capture operation. The method may include forming a mobile phase, where the mobile phase is buffered to a pH of at least 9, using a buffer system; and diluting the sample via at least one dilution where a diluent used in a final dilution is buffered to a pH of at least 9, using the same buffer system used for the mobile phase at a start of the method, and where the diluent used in a final dilution has the same composition as the mobile phase at the start of the method. The method may include obtaining fractions of the solution by separating the sample with a hydrophilic interaction liquid chromatography (HILIC) system, where the HILIC system includes a stationary phase and the mobile phase; and measuring substances in the fractions with a detector where the detector responds to the carbon capture solvent and degradation products separated in the fractions. The method may include identifying the carbon capture solvent and degradation products in the solution produced by the carbon capture operation based on a response of the detector as compared to the response of the detector from a set of standards.

In another aspect, embodiments disclosed herein relate to a method. The method may including providing a sample of a solution produced by a carbon capture operation, where the solution includes a carbon capture solvent and degradation products of the carbon capture solvent produced by the carbon capture operation. The method may include diluting the sample via a serial dilution where a diluent of a final dilution is buffered to a pH of at least 9, using a diluent where the diluent and a mobile phase use a same buffer system and have the same composition, and where the dilution is sufficient to ensure the carbon capture solvent and degradation products are in a pre-determined range for analysis and detection by a hydrophilic interaction liquid chromatography (HILIC) system coupled with a detector. The method may include calibrating the detector with a tuning mix comprising compounds with chemical structure similarities to the carbon capture solvent and degradation products; and obtaining fractions of the solution by separating the sample with the HILIC system, where the HILIC system includes a stationary phase and the mobile phase. The method may include identifying the carbon capture solvent and degradation products in the solution produced by the carbon capture operation based on matching a retention time with a retention time of a set of standards; and verifying an identity by matching properties measured by the detector of the sample compared to the set of standards where the properties are selected from the group consisting of a molecular weight, a mass spectrum, an UV spectrum, an amount of light scattered, a conductivity, or an electrical signal. The method may include measuring the fractions to determine a concentration of the carbon capture solvent and the degradation products using extracted ion chromatogram extraction.

Any combinations of the various embodiments and implementations disclosed herein can be used in a further embodiment, consistent with the disclosure. Other aspects and advantages of the claimed subject matter will be apparent from the following description and the appended claims.

### BRIEF DESCRIPTION OF DRAWINGS

FIG. 1 shows an example schematic of a liquid chromatography instrument with a mass spectroscopy instrument in accordance with one or more embodiments.

FIG. 2 shows a system in accordance with one or more embodiments.

FIG. 3 shows a flowchart in accordance with one or more embodiments.

FIG. 4 shows an example mass spectrum in accordance with one or more embodiments.

FIG. 5 shows a flowchart in accordance with one or more embodiments.

FIG. 6 shows a flowchart in accordance with one or more embodiments.

FIG. 7 shows a flowchart in accordance with one or more embodiments.

FIG. 8 shows an example of ramping of the mobile phase in accordance with one or more embodiments.

FIGS. 9A and 9B show examples of extracted ion chromatograms in accordance with one or more embodiments.

FIGS. 10A and 10B show examples of extracted ion chromatograms in accordance with one or more embodiments.

FIG. 11A shows an example extracted ion chromatogram in accordance with one or more embodiments.

FIG. 11B shows an example graph in accordance with one or more embodiments.

FIGS. 12A and 12B show examples of extracted ion chromatograms in accordance with one or more embodiments.

FIGS. 13A and 13B are example graphs in accordance with one or more embodiments.

FIGS. 14A and 14B are example chromatograms in accordance with one or more embodiments.

### DETAILED DESCRIPTION

In one aspect, embodiments disclosed herein relate to a method for identifying a carbon capture solvent and degradation products from a carbon capture operation by liquid chromatography (LC). Liquid chromatography may include a hydrophilic interaction liquid chromatography (HILIC) system. The HILIC system may include a hydrophilic stationary phase, and a mobile phase buffered to basic conditions with ammonium hydroxide, ammonium bicarbonate, triethylamine, ammonia, or ammonium carbonate. The mobile phase may include another basic buffering compound or another additive. A basic buffer may refer to a buffer that maintains a pH ranging from 9.5 to 11. The LC may include a detector. The detector may include a mass spectrometry instrument, a UV-Vis detector, an evaporative light scattering detector, an electrochemical detector, or combinations thereof. The mass spectroscopy system may include a quadrupole, a time-of-flight, or combinations thereof such as a triple quadrupole or a quadrupole time-of-flight mass analyzer.

Chromatography is a useful technique for the separation of substances in a mixture. Chromatographic separation is based on the affinity of the substances in a mixture between a stationary phase and a mobile phase. The resulting separated substances may be analyzed via a variety of methods to determine the identity of the substances, the structure of the substances, and the concentration of the substances. The present disclosure is directed towards using chromatography to resolve one or more carbon capture solvents and any degradation products from one another within a sample produced from a carbon capture operation, in order that they may be quantified. Quantification of the carbon capture solvent may allow for a carbon capture solvent concentration, CO₂ loading, and water balance to be determined in order to maintain a carbon capture operation. Identification and quantification of any degradation products may allow a carbon capture solvent health to be determined in order to determine if countermeasures, such as solvent reclaiming or secondary emissions controls, should be implemented.

### LC-MS Instrument

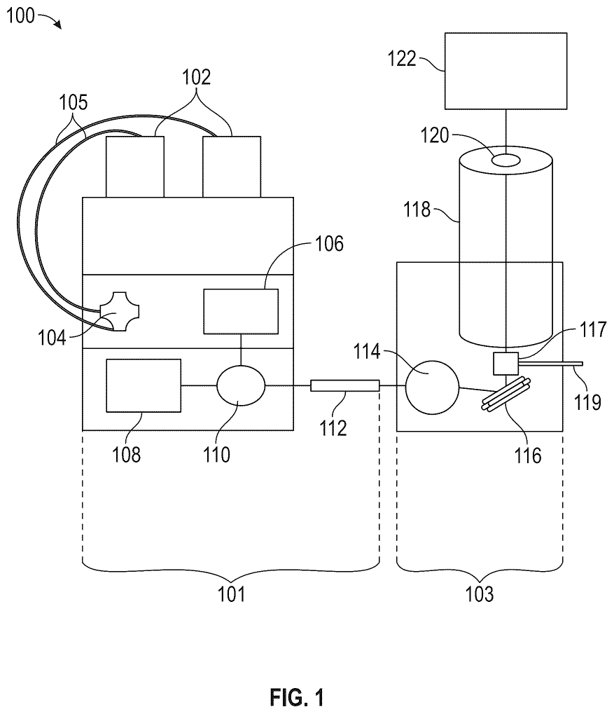

FIG. 1 shows an example schematic of a liquid chromatography-mass spectrometry (LC-MS) instrument 100, according to one or more embodiments. The LC-MS instrument 100 may be used to separate a carbon capture solvent and degradation products in a sample provided by a carbon capture operation. The LC-MS instrument 100 may identify the carbon capture solvent and degradation products from the carbon capture operation based on a retention time, a molecular weight, or a fragmentation pattern. The LC-MS instrument 100 may measure the concentration of the carbon capture solvent and degradation products by comparing a response from a mass spectrometry (MS) instrument 103 to a response from a set of standards.

The LC-MS instrument 100 is a hyphenated instrument. For the purposes of this disclosure, a hyphenated instrument is an instrument that is two or more instruments operated together. The hyphenated instrument may produce analytical results superior to the results of the individual instruments. The hyphenated instrument may include two instruments. A first instrument may be a liquid chromatography (LC) instrument 101. A second instrument, according to one or more embodiments, may be a mass spectroscopy (MS) instrument 103. The first instrument and second instrument may be operated together in a suitable fashion, such that any first instrument may be operated with any second instrument. This allows compounds to be resolved in both a time domain and a mass domain in order to provide accurate analysis of complex samples. In one or more embodiments, the LC-MS instrument 100 is a LC instrument 101 with a MS instrument 103. The LC instrument 101 may be a commercial LC instrument that is used for the separation of substances of a mixture in the liquid phase. The LC instrument 101 with a MS instrument 103 may be supplied from the same manufacturer.

The LC instrument 101 may include two or more liquid compositions in storage bottles 102. A mobile phase may be a mixture of two or more of the liquid compositions. According to one or more embodiments, the mobile phase is a mixture of a first liquid composition, termed herein a first phase and a second liquid composition, termed herein a second phase. The first phase may include a base, water, and an organic solvent. The base may include ammonium hydroxide, ammonium bicarbonate, triethylamine, ammonia, ammonium carbonate, sodium hydroxide, sodium carbonate, sodium bicarbonate, sodium borate, potassium hydroxide, potassium carbonate, potassium borate, and potassium bicarbonate. The base may have a purity equal to LC-MS grade. LC-MS grade may refer to a purity that provides a low mass noise level, minimal organic contamination, and minimal metal content. For example, the purity may be greater than 99.9% and include less than parts per billion (ppb) amounts of organic contamination and metal content. The concentration of the base before adding to the first phase may range from 1 to 100 percent by weight (wt %). The base may be independently dissolved in the water of the first phase at a concentration ranging from 0.5 to 100 mM. The first phase may have a pH range ranging from 9.5 to 11. The water may be deionized water. The water may have a purity equal to HPLC or LC-MS grade. The water may be present in the first phase at a concentration ranging from 1% by volume (% v/v) to 10% v/v. The organic solvent may include acetonitrile, methanol, or isopropyl alcohol. The organic solvent may have a purity equal to LC-MS grade.

The second phase may include a base, water, and an organic solvent. Other known polar constituents may be used for the water. The concentration of organic solvent may be less in the second phase than the first phase. The base may include ammonium hydroxide, ammonium bicarbonate, triethylamine, ammonia, ammonium carbonate, sodium hydroxide, sodium carbonate, sodium bicarbonate, sodium borate, potassium hydroxide, potassium carbonate, potassium borate, and potassium bicarbonate. The base may have a purity equal to LC-MS grade. The concentration of the base before adding to the first phase may range from 1 to 100 wt %. The base may be independently dissolved in the water of the second phase at a concentration ranging from 0.5 to 100 mM. The second phase may have a pH ranging from 9.5 to 11. The water may be deionized water. The water may have a purity equal to HPLC or LC-MS grade. The water may be present in the water of the second phase at a concentration ranging from 0.5 to 100 mM. The organic solvent may be used to stabilize the second phase and prevent bacterial contamination. The organic solvent may be present at a concentration ranging from 0 to 10% v/v in the second phase. The water may be present in the second phase at a concentration ranging from 90 to 99.99% v/v.

The pH of the first and second phase may be measured to confirm that a sufficient buffer is formed in the mobile phase and that the pH is in the target range. A pH which is too high or too low may result in shifting retention times, poor separation of compounds, or degradation of the chromatography column. The measurement of the pH and adjustment via titration up to a final pH by addition of more base may ensure that the final pH falls into a target range. The target range may be a pH ranging from 9.5 to 11. This adjustment may be needed especially when using a volatile base, such as ammonia, which may cause the concentration of base to change and the pH to drift during preparation of the first and second phase.

In one or more embodiments, the LC instrument 101 includes a solvent partitioning valve 104. The two or more phases may be transferred from the storage bottles 102 using lines 105 to the solvent partitioning valve 104. In one or more embodiments, the solvent partitioning valve 104 provides a mixture of the first phase and the second phase of the mobile phase. The LC instrument 101 may include one or more pumps 106. The pump 106 may be a reciprocating pump. The pump 106 may operate in such a way that the first and second phase are drawn into the LC instrument 101, pressurized, and mixed together to form a third phase known as the mobile phase. The mobile phase may include the first and second phase in varying proportions that may change during a method of the LC instrument 101. The mobile phase may carry a sample through the LC instrument 101 including though a column 112 to a detector. The detector may be a mass spectrometry instrument 103, a UV-Vis detector, an evaporative light-scattering detector, an ionic conductivity detector, an electrochemical detector, or combinations thereof. In one or more embodiments, the pressure of the LC instrument 101 is in a range from 200 to 1,300 bar.

In one or more embodiments, the LC instrument 101 includes sample holder 108. The sample holder 108 may be connected to an autosampler. In other embodiments, the sample holder 108 may allow for single sample analysis. The LC instrument 101 may include a sample injection valve 110. The sample injection valve 110 may be connected to the sample holder 108. In one or more embodiments, the sample injection valve 110 injects a sample from the sample holder 108 into the LC instrument 101. The injection may be a single sample or a sequence of samples via the autosampler.

The LC instrument 101 may include a column 112. The column 112 is considered the stationary phase of the LC instrument 101. In one or more embodiments, the column 112 is a zwitterionic hydrophilic interaction liquid chromatography (HILIC) column. The column 112 may be chosen based on the level of stability at a high pH. The column 112 may be stable under a pH ranging from 3 to 12. An example of a zwitterionic HILIC column may be an InfinityLab Poroshell 120 HILIC-Z (Agilent) with a 2.1 mm inner diameter, a 100 mm length, a 2.7 μm particle size, and a polyether ether ketone polymer (PEEK) lining.

The LC instrument 101 may be connected with a detector. The detector may convert chemical signals from the sample into electrical signals. The detector may be a mass spectrometry instrument, a UV-Vis detector, an evaporative light-scattering detector, an ionic conductivity detector, an electrochemical detector, a fluorescence detector, a refractive index detector, or combinations thereof.

A mass spectrometry detector (MS) may ionize analytes and measure a mass-to-charge ratios (m/z) of the analytes. MS may provide structural information about the analytes. MS may be ideal for identifying and quantifying a wide range of compounds, especially in complex mixtures. MS may have high sensitivity and selectivity, which may lead to providing both qualitative and quantitative data. MS may be used in tandem with LC in a liquid chromatography-mass spectrometry instrument (LC-MS).

A UV-Vis detector may measure a response of the sample from exposure to radiation in the UV-Visible spectrum, where the response is known as absorbance. The UV-Vis detector may measure the absorbance of ultraviolet or visible light by analytes as they pass through the UV-Vis detector. The UV-Vis detector may be suitable for analyzing compounds that absorb UV or visible light, such as aromatic compounds, organic molecules, and proteins. UV-Vis detectors may have high sensitivity and broad applicability. The range of radiation the sample is exposed to may range from 190 to 900 nanometers.

In an evaporative light-scattering detector (ELSD), the mobile phase is evaporated, leaving behind non-volatile analyte particles. A light beam then illuminates these particles, and light that is scattered is detected and quantified. ELSD may be suitable for non-volatile and semi-volatile compounds, including lipids, carbohydrates, and polymers. ELDS may detect a wide range of analytes that do not absorb UV light and are not volatile. ELSD is compatible with gradient elution, making it versatile for complex mixtures. The ELSD is particularly useful for compounds that lack chromophores and are not amenable to UV-Vis detection. ELSD may provide a broader range of applicability in LC analysis, especially when analyzing diverse, non-volatile compounds.

A conductivity detector may measure the electrical conductivity of the eluent as ions pass through the conductivity detector cell. Conductivity detectors may be used in ion chromatography for detecting ionic compounds, such as inorganic anions and cations. Conductivity detectors may be highly sensitive for ions, especially when used with a suppressor to reduce a background conductivity.

An electrochemical detector (ECD) may detect analytes based on their ability to undergo oxidation or reduction at an electrode surface. ECD may be suitable for compounds like neurotransmitters, certain pharmaceuticals, and other electroactive species. ECD may have high sensitivity and specificity for redox-active compounds.

A fluorescence detector (FLD) may detect compounds that fluoresce when exposed to a specific wavelength of light. The FLD emits light and measures the emitted fluorescence from the compound. FLD may be useful for detecting highly fluorescent compounds like pharmaceuticals, biomolecules, and environmental pollutants. FLD may be very sensitive, and thus may be used for trace-level analysis of specific compounds which fluoresce.

A refractive index detector (RID) may measure a change in a refractive index of a mobile phase as analytes pass through the RID. RID may be used for compounds that do not absorb UV light, such as sugars, alcohols, and fatty acids. RID may be considered a universal detector for non-UV-active compounds. RID may be less sensitive than other detectors. RID is known to be unsuitable for gradient elution.

Referring to FIG. 1, the LC instrument 101 is connected to a mass spectrometry (MS) instrument 103 in liquid chromatography-mass spectrometry instrument (LC-MS) 100. The MS instrument 103 may be commercially available. The MS instrument 103 may include an ionization source 114. In one or more embodiments, the ionization source is an electrospray ionization (ESI) source.

The MS instrument 103 may include one or more mass analyzer. The MS instrument 103 may include one or more mass analyzer known for use in detecting and measuring organic samples. In one or more embodiments, the MS instrument 103 includes a mass spectrometry system with a quadrupole time-of-flight (Q-TOF) mass analyzer. The Q-TOF mass analyzer is a quadrupole mass analyzer 116 connected with a time-of-flight mass analyzer 118. The Q-TOF mass analyzer may be a commercial Q-TOF instrument used for the separation and analysis of different masses in a sample. In one or more embodiments, a collision cell 117 may be included between the quadrupole mass analyzer 116 and the time-of-flight mass analyzer 118. The collision cell 117 may include a collision induced dissociation (CID) gas which is supplied by a collision gas supply 119. The CID gas may be an inert gas known for producing fragmentation in mass spectrometry.

The MS instrument 103 may include a mass spectrometry detector 120. The mass spectrometry detector 120 may convert chemical signals from the sample from the Q-TOF mass analyzer into electrical signals. In one or more embodiments, the mass spectrometry detector 120 is a 10-bit analog-to-digital converter (ADC).

The LC-MS instrument 100 may include a computer system 122. The computer system 122 may display the results from the LC-MS instrument 100. The results may include chromatograms and mass spectrums.

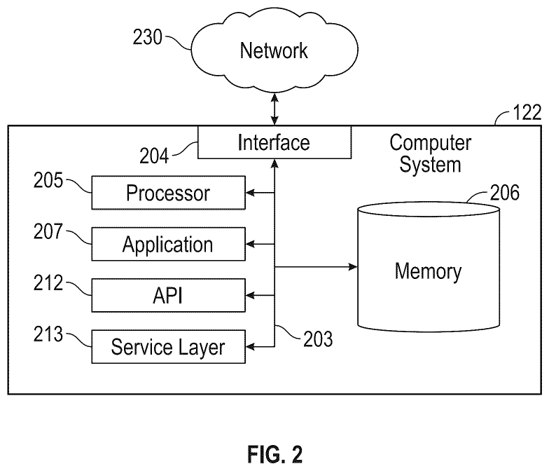

FIG. 2 shows a system in accordance with one or more embodiments. The computer system 122 is used to provide computational functionalities associated with described algorithms, methods, functions, processes, flows, and procedures as described in the present disclosure, according to one or more embodiments. The illustrated computer system 122 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer system 122 may include an input device, such as a keypad, keyboard, touch screen, or other device that can accept user information, and an output device that conveys information associated with the operation of the computer system 122, including digital data, visual, or audio information (or a combination of information), or a graphical user interface (GUI).

The computer system 122 can serve in a role as a client, network component, a server, a database or other persistency, or any other component (or a combination of roles) of a computer system for performing the subject matter described in the instant disclosure. The illustrated computer system 122 is communicably coupled with a network 230. In some implementations, one or more components of the computer system 122 may be configured to operate within environments, including cloud-computing-based, local, global, or other environments (or a combination of environments).

At a high level, the computer system 122 is an electronic computing device operable to receive, transmit, process, store, or manage data and information associated with the described subject matter. According to some implementations, the computer system 122 may also include or be communicably coupled with an application server, e-mail server, web server, caching server, streaming data server, business intelligence (BI) server, or other server (or a combination of servers).

The computer system 122 can receive requests over network 230 from a client application, for example, executing on another computer system 122 and responding to the received requests by processing the said requests in an appropriate software application. In addition, requests may also be sent to the computer system 122 from internal users (for example, from a command console or by other appropriate access method), external or third-parties, other automated applications, as well as any other appropriate entities, individuals, systems, or computers.

The computer system 122 includes an interface 204. The interface 204 is used by the computer system 122 for communicating with other systems in a distributed environment that are connected to the network 230. Generally, the interface 204 includes logic encoded in software or hardware (or a combination of software and hardware) and operable to communicate with the network 230. More specifically, the interface 204 may include software supporting one or more communication protocols associated with communications such that the network 230 or interface's hardware is operable to communicate physical signals within and outside of the illustrated computer system 122.

The computer system 122 also includes at least one computer processor 205. Generally, the computer processor 205 executes instructions and manipulates data to perform the operations of the computer system 122 and any algorithms, methods, functions, processes, flows, and procedures as described in the instant disclosure.

The computer system 122 further includes a memory 206 that holds data for the computer system 122 or other components (or a combination of both) that can be connected to the network 230. For example, memory 206 can be a database storing data consistent with this disclosure. While memory 206 is illustrated as an integral component of the computer system 122, in alternative implementations, memory 206 can be external to the computer system 122.

The application 207 is an algorithmic software engine providing functionality according to particular needs, desires, or particular implementations of the computer system 122, particularly with respect to functionality described in this disclosure. For example, application 207 can serve as one or more components, modules, applications, etc. Further, although illustrated as a single application 207, the application 207 may be implemented as multiple applications 207 on the computer system 122. In addition, although illustrated as integral to the computer system 122, in alternative implementations, the application 207 can be external to the computer system 122.

Each of the components of the computer system 122 can communicate using a system bus 203. In some implementations, any or all of the components of the computer system 122, both hardware or software (or a combination of hardware and software), may interface with each other or the interface 204 (or a combination of both) over the system bus 203 using an application programming interface (API) 212 or a service layer 213 or a combination of the API 212 and service layer 213. The API 212 may include specifications for routines, data structures, and object classes. The API 212 may be either computer-language independent or dependent and refer to a complete interface, a single function, or even a set of APIs.

The service layer 213 provides software services to the computer system 122 or other components (whether illustrated or not) that are communicably coupled to the computer system 122. The functionality of the computer system 122 may be accessible for all service consumers using this service layer. Software services, such as those provided by the service layer 213, provide reusable, defined business functionalities through a defined interface. For example, the interface may be software written in JAVA, C++, or other suitable language providing data in extensible markup language (XML) format or another suitable format. While illustrated as an integrated component of the computer system 122, alternative implementations may illustrate the API 212 or the service layer 213 as stand-alone components in relation to other components of the computer system 122 or other components (whether or not illustrated) that are communicably coupled to the computer system 122. Moreover, any or all parts of the API 212 or the service layer 213 may be implemented as child or sub-modules of another software module, enterprise application, or hardware module without departing from the scope of this disclosure.

### Method for Identifying Carbon Capture Solvent and Degration Products

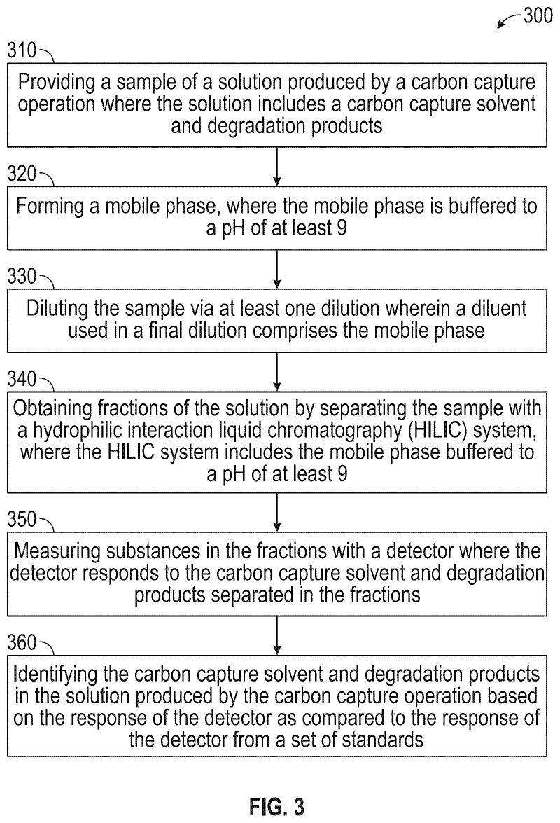

Embodiments disclosed herein relate to a method for identifying a carbon capture solvent and degradation products from a carbon capture operation by liquid chromatography with mass spectrometry (LC-MS). The method, according to one or more embodiments, is shown in the flowchart of FIG. 3. The method 300 may include providing a sample of a solution produced by a carbon capture operation, forming a mobile phase where the mobile phase is buffered to a pH of least 9, diluting the sample with at least one dilution, obtaining fractions of the solution by separating the sample with a hydrophilic interaction liquid chromatography (HILIC) system, measuring substances in the fractions with a detector, where the detector may include a mass spectrometry instrument, a UV-Visible detector, and combinations thereof, and identifying the carbon capture solvent and degradation products in the solution produced by the carbon capture operation.

The method 300 may include, at block 310, providing a sample of a solution produced by a carbon capture operation. The carbon capture operation may include a suitable carbon capture operation that uses carbon capture solvents to selectively remove carbon dioxide (CO₂) from industrial flue gases, natural gas, or other industrial sources. CO₂ may be selectively removed via chemical and/or physical absorption by the carbon capture solvent. The carbon capture solution may include an aqueous mixture including a range of 10 to 70% v/v of an amine, alkali metal salt, amino acid, or combinations thereof. The carbon capture solution may include water. Suitable amines may include common amines with a molar mass under 200 g/mol. Examples of the amine or amino acid may include, ethanolamine (MEA), diglycolamine (DGA), piperazine (PZ), diethanolamine (DEA) and diisopropanolamine (DIPA), triethanolamine (TEA), methyldiethanolamine (MDEA), or combinations thereof. In one or more embodiments, the carbon capture solvent is ethanolamine (MEA).

The carbon capture operation may produce a solution after the CO₂ is selectively captured by the carbon capture solvent. The solution may include the carbon capture solvent. The solution may further include degradation products of the carbon capture solvent. Degradation products of the carbon capture solvent may be produced by oxidative degradation and thermal degradation, or reaction of the capture solvent with exhaust impurities such as SO₂, NOₓ, organic impurities, fly ash, or metals. The degradation products may include primary degradation products. The primary degradation products may undergo further reactions with the carbon capture solvent and other primary degradation products to form secondary degradation products. The secondary degradation products may also undergo further reactions. The degradation products may be used to indicate degradation of the carbon capture solvent.

The method 300 may include, at block 320, forming a mobile phase, where the mobile phase is buffered to a pH of at least 9. A buffer system may include an acid or base in the presence of the acid or base's conjugate base or acid, respectively. The buffer system may be used to buffer the mobile phase to a pH of at least 9. The mobile phase may have a concentration gradient resulting from changing an amount of a first phase and a second phase. The first phase and second phase are as previously described and may include a base, water, and an organic solvent. The base may be independently dissolved in the water of the first and second phase. Bases may be used to buffer the mobile phase against addition of a sample, which may have a pH which is lower than the buffer. In some embodiments, an additional component may be added to adjust the final pH of an eluent (i.e., the mobile phase plus a sample of the solution produced by the carbon capture operation). Formulating the buffer system with high pH (i.e., a pH ranging from 10 to 11) may include adding an alkali metal carbonate or borate, such as sodium carbonate or sodium borate. The base may may be independently in the water of the first and second phase in a concentration ranging from 0.5 to 100 mM.

The first phase and second phase may have partition coefficients. The partition coefficient may describe the ratio of water to organic solvent in each phase. In one or more embodiments, the first phase has a water-octanol first partition coefficient that is greater than about 0.3. The second phase may have a water-octanol second partition coefficient that is less than about 0.25. The difference in the partition coefficient may result in the first phase being less polar than the second phase. As the first phase includes a greater percent volume of organic solvent, it is less polar than the second phase, which includes a greater percent volume of water.

The method 300 may include, at block 330, diluting the sample via at least one dilution where the final dilution includes a diluent of the mobile phase buffered to a pH of at least 9. The diluent may be buffered using the same buffer system as the mobile phase. The diluent may also be a diluting agent. Diluting the sample may occur via one dilution where the one dilution is the final dilution. In other embodiments, diluting the sample may occur via a serial dilution of two or more dilutions. The sample may be diluted for the final dilution with a diluent of the mobile phase buffered to a pH of 9.

The sample may be diluted based on a dilution factor. The dilution factor may range from 1,000 to 20,000 for the carbon capture solvent. The dilution factor may range from 10 to 1,000 for the degradation compounds, as the degradation compounds may have a smaller concentration in the original solution. One or more dilutions may be sufficient to produce a final concentration of the carbon capture solvent and degradation products in the range of about 10 to 1000 μM. In one or more embodiments, the final concentration of the carbon capture solvent and degradation products is in the range of about 50 to 500 μM. In other embodiments, the final concentration is in the range of about 100 to 300 μM.

The method 300 may include, at block 340, obtaining fractions of the solution by separating the sample with a HILIC system. The HILIC system may be included in the LC instrument 101. The HILIC system may include a polar stationary phase (i.e., column 112) and the mobile phase buffered to a pH of at least 9. The mobile phase is as previously described. The polar stationary phase (i.e., column 112) may be hydrophilic. The column 112 may be a zwitterionic HILIC column.

Obtaining fractions of the solution may include injecting the solution produced by the carbon capture operation into the LC instrument 101. The solution may be injected from the sample holder 108 via the sample injection valve 110. The solution may be injected by an autosampler. The solution may be injected at a volume ranging from 5 to 20 microliters.

Obtaining fractions of the solution may include separating the sample with the HILIC system. Separating the sample may occur by polar/nonpolar interactions of substances in the sample between the mobile phase and a liquid boundary layer which surrounds the stationary phase of the column 112 of the HILIC system. Polar analytes may prefer the highly polar liquid boundary layer which surrounds the polar stationary phase of column 112 of the HILIC system. The polar stationary phase may be a silica-based material. The preference of polar analytes for the highly polar liquid boundary layer may cause the polar analytes to diffuse from the mobile phase into the liquid boundary layer surrounding the stationary phase. The polar analytes may remain in the liquid boundary layer when the mobile phase is less polar. As the mobile phase becomes more polar, the polar analytes may begin to migrate back into the mobile phase. A retention time of a given compound may be determined by its relative preference for the mobile phase. As such, the retention time may be proportional to the amount of time a given compound remains in the liquid boundary layer of the column 112. For example, a more polar substance in the sample may interact with the column 112 more strongly than with the mobile phase. The stronger interaction leads to the more polar substance remaining in the column 112 for a longer period of time, allowing the less polar substance to separate from the sample first. The retention time may also include a dead time. The dead time may include the time the sample travels through the column 112 and the flow lines of the LC instrument 101.

The HILIC system may have a flow rate to change the rate of the mobile phase moving through the HILIC system. Increasing the flow rate may lead to earlier retention times. However, an increased flow rate may also lead to poor separation due to blending of the substances in the sample. In one or more embodiments, the flow rate of the HILIC system may range from 0.2 to 0.3 milliliters per minute (mL/min).

The HILIC system may have a dwell time. The dwell time may relate to the amount of time the sample remains in a sample loop before being injected onto the column. The HILIC system may have a dwell time ranging from 0 to 5 minutes.

A basic pH of the mobile phase may affect the ionization of the substances in the sample, thus affecting the polarity of the substances in the sample. This effect may lead to the substances interacting with the column for a different amount of time compared to a neutral or acidic pH mobile phase. For example, at a high pH, more acidic substances (i.e., substances with pKa less than the pH of the mobile phase) may be predominantly deprotonated. Carboxylate or sulfonate functional groups on these substances may carry a negative charge, making the substances more polar. On the other hand, alkaline functional groups, such as nitrogen moieties, may tend to be deprotonated. Deprotonating of the alkaline substances may yield a neutral state and thus, a less polar substance. Thus, the pH of the mobile phase and sample diluent (i.e., a solvent used for the final dilution of a sample) may be used to selectively alter the polarity. Selectively altering the polarity may selectively alter the retention time, leading to better separation of the substances selected. In one or more embodiments, the temperature of the column 112 may be adjusted during separation. The temperature of the column 112 may range from 20 to 40° C.

During separation of the sample with the HILIC system, the mobile phase may be changed to optimize the separation of the substances within the sample. The mobile phase may have a concentration gradient. The concentration gradient of the mobile phase may be changed by changing an amount of a first phase and a second phase. The first and second phase are as previously described. As both the first phase and second phase include water or another polar constituent, the concentration gradient of the mobile phase may also yield a variable amount of water. The mobile phased may be formed by changing the concentration of water in the mobile phase from about 1 to 10% v/v at the start of the method to about 25 to 50% v/v at the end of the method.

The concentration gradient may be formed by changing the amount of the first phase and second phase. Changing the amount of two or more phases is known as ramping. Ramping may occur over a time period ranging from around 2 to 30 minutes. In one or more embodiments, the ramping has a time period ranging from 4 to 15 minutes. Ramping may result in separation of fractions of the sample produced by the carbon capture operation. The fractions may include the separated carbon capture solvent and degradation products. A longer time period for ramping may increase the separation between retention times of substances since there may be more time for equilibration to occur as the mobile phase composition is changing. However, a longer time period may lead to longer method times, greater eluent consumption, lower sample throughput, and wider peaks, which may cause resolution to decrease.

Metrics for measuring the performance of a separation may include retention time, resolution, peak width, peak symmetry, tailing factor, number of theoretical plates, selectivity, capacity factor, or signal to noise ratio. Resolution may be determined by comparing retention times and peak widths of two substances, as shown in Equation 1 below.

$${R}_{1 , 2} = \frac{2 * ( {t}_{1} - {t}_{2} )}{w 1 + w 2} \qquad ( Equation 1 )$$

R_{1,2} is the resolution between substance 1 and 2, t₁ is the retention time of the first substance, t₂ is the retention time of the second substance, w₁ is the width of the peak of the first substance, and w₂ is the width of the peak of the second substance. Capacity may be determined by comparing the retention times of one substance to the time it takes the mobile phase to elute off the column (i.e., dead time or void time), as shown in Equation 2.

$${k}_{i} = \frac{{t}_{i} - {t}_{0}}{{t}_{0}} \qquad ( Equation 2 )$$

kᵢ is the capacity factor of substance i, tᵢ is the retention time of substance i, and t₀ is the dead time (i.e., the void time). Selectively may be determined by comparing the capacity factor of two substances, as shown in Equation 3.

$${α}_{1 , 2} = \frac{{k}_{2}}{{k}_{1}} \qquad ( Equation 3 )$$

α_{1,2} is the selectivity of substance 2 in respect to substance 1, k₂ is the capacity factor of substance 1, and k₁ is the capacity factor of substance 2. Tailing factor may be determined by analyzing peak characteristics of the peak that results when a substance elutes off the column. Peak characteristics may include peak height and width. The peak width may be the width at half the height of the peak (w_{0.5}), or at another height of x (wₓ). The tailing factor may be determined as shown in Equation 4.

$$T = \frac{{w}_{0.05}}{2 * f} \qquad ( Equation 4 )$$

T is the tailing factor, w_{0.05} is the peak width at 5% height, and f is the distance from the peak apex to the leading edge of the peak at 5% height. The number of theoretical plates may be determined by comparing the retention time for a substance to the peak width at half height, as shown in Equation 5.

$${N}_{i} = 5.54 * {( \frac{{t}_{i}}{{w}_{0.5}} )}^{2} \qquad ( Equation 5 )$$

N is the number of theoretical plates, tᵢ is the retention time for substance i, and w_{0.5} is the peak width at half height.

The method 300 may include, at block 350, measuring substances in the fractions with a detector where the detector responds to the carbon capture solvent and degradation products separated in the fractions. The detector may be of a mass spectrometry instrument, a UV-Visible detector, and combinations thereof. The mass spectrometry instrument may include a quadrupole time-of-flight mass analyzer (Q-TOF). Substances in the fractions produced from separating the sample with a HILIC system may be ionized prior to being measured. The substances may be ionized by an ionization source 114. In one or more embodiments, the substances are ionized by electrospray ionization (ESI). An ESI source may be used to apply a charge to the substances, which may produce ions. Ionizing the substances may also include converting the substances from a liquid to a gas. During ESI, the substances may be sprayed from a small tube into a stream of nitrogen gas. Spraying a liquid from a small tube into a stream of nitrogen gas produces an aerosol. The aerosol may then evaporate into a gas in the nitrogen stream. The charge may be applied at the same time as the liquid is sprayed from the small tube. In this manner, the substances may be simultaneously ionized and converted to a gas. In one or more embodiments, the ESI is operated in positive mode. The voltage applied may be in a range from 3, 000 to 6,000 V.

Measuring ions of the substances produced by ESI may include sorting the ions with one or more detectors. The detectors may be mass analyzers. In one or more embodiments, the mass analyzer is a quadrupole mass analyzer connected to a time-of-flight (Q-TOF) mass analyzer. The ions are first sorted by the quadrupole mass analyzer 116. The quadrupole mass analyzer 116 sorts ions by scanning over an increasing mass-to-charge (m/z) ratio. Ions with different m/z strike different places on the detector allowing the ions to be detected apart from species with a different m/z. This may allow substances of interest to be resolved in both a time and mass dimension, which may result in deconvolution of complex mixtures including those which are chemically similar (and have similar polarity) but different molecular weight, as well as those which are molecular isotopes but have different structure and thus different retention times. A positive charge may be created by adding a proton to an ion. Thus, the m/z ratio may be the molecular weight plus one. The ions may be scanned over a molecular weight ranging from 40 atomic mass units (amu) to 500 amu. In one or more embodiments, the molecular weight ranges from 60 amu to 200 amu.

After the quadrupole mass analyzer 116, the ions may be sorted by the time-of-flight mass analyzer 118. The time-of-flight mass analyzer 118 sorts the ions by molecular weight. The ions are accelerated into a drift tube of the mass analyzer. The acceleration ensures that all the ions have a same kinetic energy when entering the drift tube. Once in the drift tube, the ions are then sorted by time traveled in the drift tube. The time traveled in the drift tube is directly proportional to the molecular weight. Smaller molecular weights travel for less time, while larger molecular weights travel for more time. The molecular weight of ions of substances may be measured by m/z. Ions of substances in the fractions sorted by the time-of-flight mass analyzer 118 may have molecular weights ranging from 40 amu to 500 amu. In one or more embodiments, the ions of substances sorted by the time-of-flight mass analyzer have molecular weights ranging from 60 amu to 200 amu.

Chemicals signals from the ions sorted by the Q-TOF mass analyzer may be converted into electrical signals by a mass spectrometry detector 120. The electrical signals from the Q-TOF mass analyzer may be converted to generate a mass spectrum. Mass spectrums display m/z ratio on the x-axis and a signal intensity from the detector at that m/z on the y-axis. Generating mass spectrums may lead to the identification and quantification of the carbon capture solvent and degradation products in the sample.

The method 300 may also include generating chromatograms. A detector may convert chemical signals from substances in the fractions of the separated sample from the HILIC system into electrical signals. The electric signals from the HILIC system may be converted to generate a chromatogram. Chromatograms display the time substances elute off a column on the x-axis. This time is known as the retention time. Chromatograms display the intensity of the electrical signals on the y-axis. The unit of intensity depends on the type of detector used.

In one or more embodiments, the detector is selected from a group consisting of a mass spectrometry instrument, a UV-Visible detector, an evaporative light-scattering detector, an ionic conductivity detector, an electrochemical detector, a fluorescence detector, a refractive index detector, and combinations thereof. A chromatogram generated when a mass spectroscopy instrument is the detector may include the intensity of a total ion current or a specific ion m/z ratio on the y-axis. The x-axis may be the time in which the intensity of the total ion current or a specific ion m/z ratio is measured. The total ion current is the current produced by the detector in response to all the ions in the solution. The area under a peak produced at a retention time may be correlated to concentration. Widths of a peak may be correlated to the performance of the LC-MS instrument. Generating chromatograms may lead to the identification and quantification of the carbon capture solvent and degradation products in the sample.

The method 300 may include, at block 360, identifying the carbon capture solvent and degradation products in the solution produced by the carbon capture operation based on the response of the detector as compared to the response of the detector from a set of standards. The set of standards may be commercially obtained carbon capture solvents and degradation products with a purity of at least 95%. Identifying the carbon capture solvent and degradation products may include opening the chromatograms via a data analysis software on the computer system 122. Data analysis software known to be suitable for analyzing chromatograms may be used. The analysis software may identify and quantify compounds using the chromatograms and mass spectrums. Data analysis software may be supplied by the manufacturer of the LC-MS instrument 100. Data analysis software may be used to automatically detect peaks, identify a baseline, and calculate a peak height, width, area, and retention time.

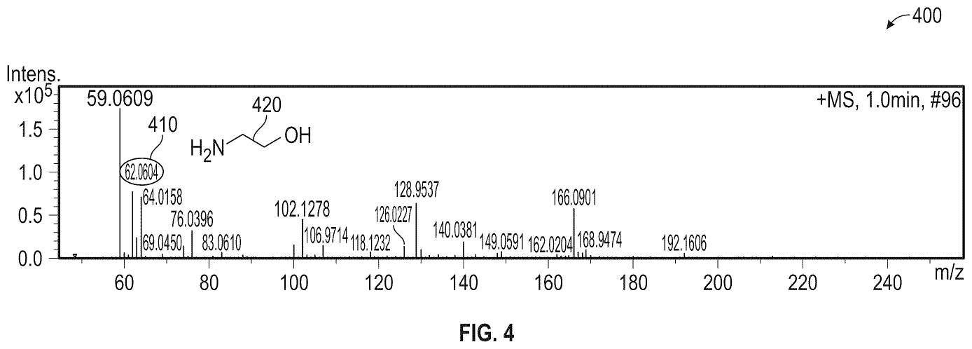

Identifying the carbon capture solvent and degradation products may include examining peaks in the chromatograms. A peak may be identified if a total ion current from the detector rises above and then returns to a baseline noise level of the detector. The baseline intensity may be about 100 to ×10⁴ counts per second (cps). A peak with a height at least three times the baseline intensity may also indicate that a substance is eluting off the column at a concentration which is above a detection limit of the LC-MS instrument. In one or more embodiment, the detection limit is a concentration ranging from 1 to 100 μM. The detection limit may depend on the peak width, the baseline noise level of the LC-MS instrument, and how readily the substance ionizes. A peak may also be detected using a single (extracted) ion chromatogram, which may only count the ions detected in a specific mass range. Detection using a single (extracted) ion chromatogram may reduce an intensity of a signal, but it may also reduce the noise level. This may thus provide a more accurate detection of a target analyte. Baseline intensity for a single ion chromatogram in LC-MS QTOF analysis may be around 1 to 500 counts per second. Once peaks have been identified based on detector deviation from the baseline, the mass spectrum for those substances may be used to determine the molecular weight. From examining the mass spectrum of a peak in the chromatogram, the peak with the highest intensity may represent the molecular weight plus one of the substance eluting off the column at the time as indicated by the peak. This peak is known as the molecular ion peak. In one or more embodiments, the molecular weight represented by the molecular ion peak is matched with molecular weight of the carbon capture solvent and known or suspected degradation products for identification. An example mass spectrum 400 is shown in FIG. 4. In the example mass spectrum 400, the peak 410 may correspond to the structure 420 (i.e., MEA). Once a molecular weight of the peak has been identified, a single ion chromatogram may be constructed which shows only the detector response for a particular m/z. The single ion chromatogram may have a lower overall intensity. It may also have a much higher signal-to-noise ratio as compared to the total ion current, since the background signal for an individual mass is also much lower.

The method 300 may further include performing extracted ion chromatogram extraction and measuring the concentration of a carbon capture solvent and degradation products in a sample from a carbon capture operation. Measuring amounts of the carbon capture solvent and the degradation products may include exporting the related chromatograms and mass spectrums using the computer system 122. Once exported, the related chromatograms and mass spectrums may be imported into an analysis software on the computer system 122. The analysis software may identify and quantify compounds using the chromatograms and mass spectrums based on previously described criteria. The analysis software may be provided by the manufacturer of the LC-MS instrument 100.

After importing the mass spectrums at each time interval into the analysis software, the method 300 may include setting parameters to perform extracted ion chromatogram (EIC) extraction using a specified mass range for each target compound, followed by peak identification, and feature analysis within the EIC using an expected retention time or retention index. The parameters determined from the EIC peaks may include retention time, peak height, peak width, peak area. Each substance may have a unique retention time, however other parameters such as the mass range, retention time tolerance, signal to noise ratio, and max area to height ratio may be the same for all compounds. An example of some parameters for quantification of MEA are shown in the Table 1 below.

TABLE 1
Example parameters determined from EIC

| Parameter | | | |
|---|---|---|---|
| Mass range | EIC extraction | +/−35 | mDa |
| Retention time | Peak identification | 7 | min |
| Retention time tolerance | Peak identification | +/−0.5 | min |

| | | |
|---|---|---|
| Signal/noise ratio (peak | Peak identification | 3 |
| height) | | |
| Max area/height ratio | Peak identification | 8 |

After the parameters are set to perform EIC extraction, the EIC may be generated. The EIC displays the intensity of a selected ion over time based on selected m/z ratios. The m/z ratios may be selected based on the peaks identified in the chromatogram. This allows for monitoring of ions at the selected m/z ratios as they increase or decrease in intensity over time. Ions may be selected that correspond to the carbon capture solvent and known or expected degradation products. The EICs of the carbon capture solvent and degradation products may provide the data required to confirm identification. Further the EICs may provide the data required to determine the amounts of the carbon capture solvent and degradation products. Calibration curves may be made using pure samples of the carbon capture solvent and degradation products. The calibration curves may allow for determining the amounts of the carbon capture solvent and degradation products in the solution.

Measuring the amounts of the carbon capture solvent and degradation products may include generating calibration curves. Calibration curves may be generated by obtaining a set of standards of the carbon capture solvent and degradation products. A standard with a purity of at least 95% preferred. In one or more embodiments, the standard is a mixture of standards of the carbon capture solvent and degradation products. If the standard is a mixture, the concentrations as indicated by the standard mixture manufacturer may be used for generating the calibration curve. A plurality of different concentrations of each standard may be prepared. The concentrations may depend on the expected concentration of the sample from the carbon capture operation. The plurality of different concentrations of each standard may be separated with the HILIC system and measured by the detector with the same method as previously described for the sample from the carbon capture operation. Data obtained from the EIC extraction (such as the peak area or height) may be used to generate a calibration curve. The calibration curve may include an equation that may be used to determine an unknown concentration. The equation may be determined by a linear least squares regression analysis or a polynomial regression analysis. Internal standards may also be used to determine the amounts of carbon capture solvent and degradation products. The internal standards may include isotopic compounds in a mass range similar to the carbon capture solvent and degradation products which have similar chemical structures. For example, the internal standard may include a ¹³C isotopic compound for the substance of interest. A report may be produced from determining the amounts of the carbon capture solvent and degradation products using the analysis software on the computer system 122. As described above, the computer system 122 may be incorporated into the LC-MS instrument 100.

Determining the amounts of the carbon capture solvent and degradation products may result in establishing validation parameters. The validation parameters may include precision, accuracy, a signal-to-noise ratio, and a limit of quantification. For example, determining the amounts of the carbon capture solvent and degradation products may result in a precision of less than or equal to 1% variation between repeat measurements based on sequential injections from the same diluted sample. Variation may be measured by calculating standard deviation between repeat measurements of the same concentration. The equation for standard deviation used is shown in Equation 6.

$${S}_{res} = \sqrt{\frac{\sum {( Y - {Y}_{est} )}^{2}}{n - 2}} \qquad ( Equation 6 )$$

sᵣₑₛ is the residual standard deviation, Y is the observed value, Yₑₛₜ is the estimated or projected value, and n is the data points in the population.

Determining the amounts of the carbon capture solvent and degradation products may result in an accuracy of less than or equal to 3% error. Error may be measured as percent error between a known concentration and a determined concentration, as shown in Equation 7. The measured concentration may be that predicted from a calibration curve. An error in the calibration curve may be the root mean squared error (RMSE of the calibration curve. The percent error may be the RMSE divided by the measured sample concentration.

$$Perecent Error = \frac{\vert ( known concentration - measured concentration ) \vert}{known concentration} \times 100 \qquad ( Equation 7 )$$

To ensure the LC-MS instrument is calibrated, a tuning mix may be prepared and measured using method 300. The tuning mixture may be directly measured by the MS instrument. The tuning mix may include a solution of a carbon capture solvent. The tuning mix may also include solutions of compounds which have chemical structure similarities to the carbon capture solvent and the degradation products. The compounds may also cover the expected molecular weight range of the carbon capture solvent and degradation products. For example, the tuning mixture may include a solution of compounds including ethylenediamine (MW 60.1), (glycine (MW 75.07), piperazine (MW 86.136), methyl diethanolamine (119.163), and bicine (MW 163.17). The tuning mixture may contain at least 4 compounds for mass calibration. In one or more embodiments, the tuning mixture does not contain any compounds which are also be included in the sample. The compounds may be added to the tuning mix so that each is in a range of 1 to 20 mmol. For example, the solution of ethylene diamine may be prepared by dissolving the ethylene diamine in the first solvent of the mobile phase. The solutions of bicine and glycine may be prepared by dissolving each in a 1:1 molar ratio to KOH in water and then diluting in the first solvent. All the solutions may be combined to form the tuning mix, where the concentration of each is in a range of 1 to 20 mmol.

Ions of a range of molecular weights may result from measuring the tuning mix by method 300. The ions may be used to calibrate the mass spectroscopy instrument using a high order harmonic polynomial cell (HPC) polynomial. HPC is a high order polynomial used to calibrate the MS instrument for measuring the mass of the ions. A minimum of 5 ions may be needed for the HPC polynomial. A value used to verify proper tuning may be a result of less than 0.05 ppm standard deviation for the fit using the exact masses of the ions.

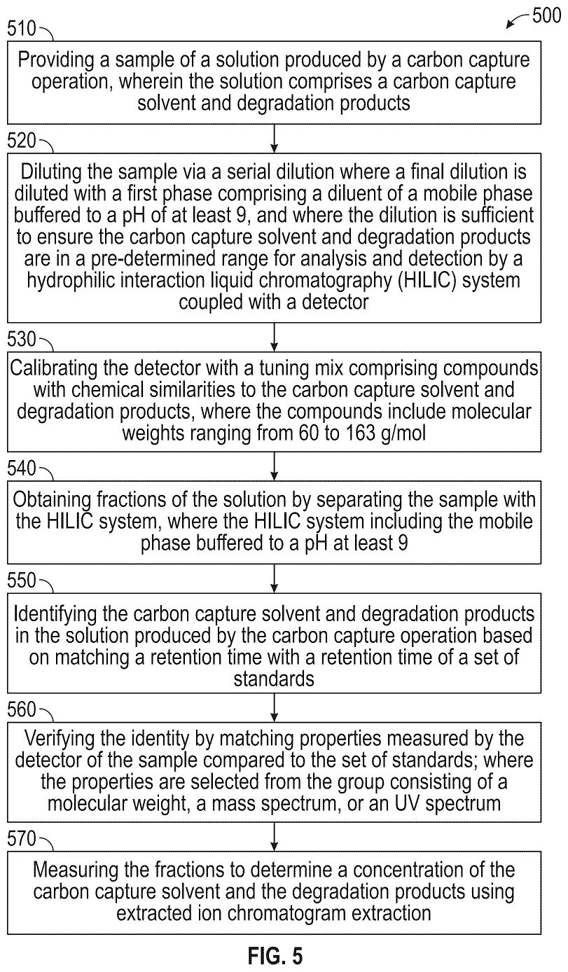

In one or more embodiments, an example of the method 300 is shown in the flowchart of FIG. 5. The example method 500 may include the same method as described in method 300. The example method 500 includes, at block 510, providing a sample of a solution produced by a carbon capture operation, where the solution comprises a carbon capture solvent and degradation products of the carbon capture solvent produced by the carbon capture operation.

The example method 500 includes, at block 520, diluting the sample via a serial dilution. A final dilution in the serial dilution may include a diluent of a mobile phase buffered to a pH of at least 9. The serial dilution may be sufficient to ensure the carbon capture solvent and degradation products are in a pre-determined range for analysis and detection by a hydrophilic interaction liquid chromatography (HILIC) system coupled with a detector. The detector may be a mass spectrometry system, a UV-Vis spectroscopy system, or combinations thereof. The mass spectrometry system may include a quadrupole time-of-flight (QTOF) detector.

The example method includes, at block 530, calibrating the detector with a tuning mix including compounds with chemical structure similarities to the carbon capture solvent and degradation products. The tuning mix is as described in method 300. The compounds may have molecular weights ranging from 60 g/mol to 200 g/mol. Ions resulting from the tuning mix may be used to calibrate the mass spectroscopy system using a high order HPC polynomial. The example method 500 includes, at block 540, obtaining fractions of the solution by separating the sample with the HILIC system. The HILIC system may include the mobile phase buffered to a pH at least 9. The mobile phase is as described in method 300. Fractions may be obtained as described in method 300.

The example method 500 includes, at block 550, identifying the carbon capture solvent and degradation products in the solution produced by the carbon capture operation. Identification may be based on matching a retention time from substances in the fractions with a retention time of a set of standards. The set of standards is as described in method 300.

The example method includes, at block 560, verifying the identity by matching properties measured by the detector of the sample compared to the set of standards. The properties may be a molecular weight, a mass spectrum, an UV spectrum, amount of light scattered, conductivity, or electrical signal. The identity of the carbon capture solvent and degradation products may be verified by comparing the molecular weight, mass spectrum, UV spectrum, amount of light scattered, conductivity, or electrical signal of the carbon capture solvent and degradation product to the molecular weight, mass spectrum, UV spectrum, amount of light scattered, conductivity, or electrical signal of the corresponding standard.

The example method includes, at block 570, measuring the fractions to determine a concentration of the carbon capture solvent and the degradation products using extracted ion chromatogram extraction. Measuring the concentration of the carbon capture solvent and degradation products is as described in method 300. Extracted ion chromatogram extraction is as described in method 300.

### Method for Management of Carbon Capture Operation

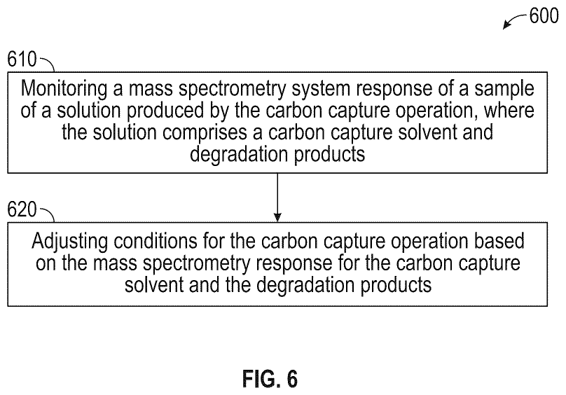

Embodiments disclosed herein are related to a method for management of a carbon capture operation. The method 600 is shown in a flowchart in FIG. 6. The method 600 may include, at block 610, monitoring a mass spectrometry instrument response of a sample of a solution produced by the carbon capture operation. The solution may include a carbon capture solvent and degradation products of the carbon capture solvent. Monitoring may include identifying the carbon capture solvent and degradation products using method 300 as described above. Monitoring may further include determining amounts of the carbon capture solvent and the degradation products using method 300 as described above.

The identification of the carbon capture solvent and degradation products may result in, at block 620, adjusting conditions for the carbon capture operation based on the mass spectrometry response. Adjusting conditions for the carbon capture operation may include adjusting the temperature of the carbon capture operation. The temperature may be adjusted based on the inferred degradation rates that are measured experimentally. For example, a temperature is picked based on a degradation tolerance that is acceptable operationally. The temperature may be adjusted to achieve desired outcomes. Desired outcomes may include minimum disturbance to the carbon capture operation, good performance, and minimized costs associated with solvent replacement. Operationally acceptable degradation tolerance may ensure minimum disturbance to the carbon capture operation, good performance, and minimized costs associated with solvent replacement.

Adjusting the conditions for the carbon capture operation may include adjusting a liquid circulation rate of the carbon capture operation. The liquid circulation rate may be adjusted to ensure performance of the system. For example, if the solvent concentration decreases due to degradation, increased circulation rate may help compensate for a reduction in the solvent's capacity for CO₂ due to the reduced solvent concentration. Similarly, a pressure in a stripper may be reduced. A temperature in the stripper may also be increased to increase the free amine concentration in the solvent. Alternatively, the temperature in the stripper may be reduced if certain degradation products are detected to avoid exacerbating corrosion.

Adjusting the conditions for the carbon capture operation may include modifying the carbon capture solution composition. Modification may be addition of solvent, removal of degraded solvent, addition or removal of water from the solution, or addition of additives, such as degradation inhibitors, corrosion inhibitors, or caustic. Other countermeasures may also be deployed, such as thermal reclaiming, carbon treating, ion exchange treatment, flue gas pretreatment, or dissolved and entrained oxygen removal.

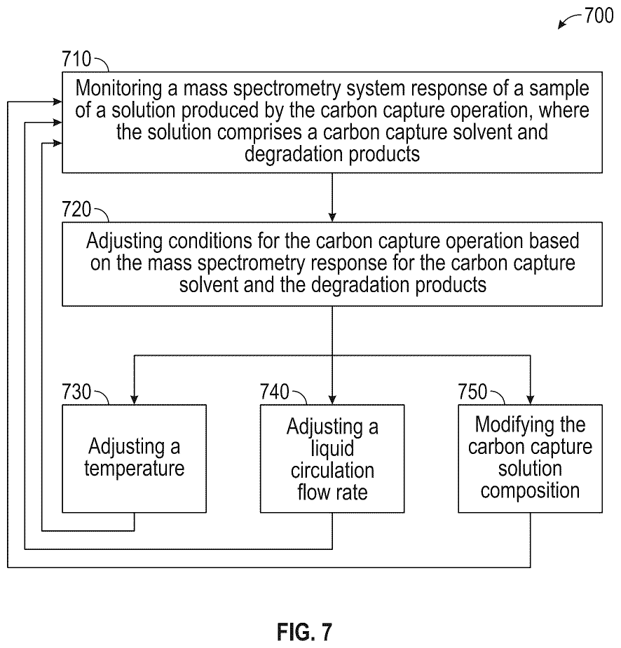

In one or more embodiments, an example of the method 600 is shown in the flowchart of FIG. 7. The example method 700 may include the same method as described in method 600. The example method includes, at block 710, monitoring a mass spectrometry system response of a sample of a solution produced by the carbon capture operation. The solution may include a carbon capture solvent and degradation products of the carbon capture solvent. Monitoring may include identifying the carbon capture solvent and degradation products using method 300 as described above. Monitoring may further include determining amounts of the carbon capture solvent and the degradation products using method 300 as described above.

The example method 700 includes, at block 720, adjusting conditions for the carbon capture operation based on the mass spectrometry response. Adjusting conditions for the carbon capture operation may include one or more pathways. One pathway, at block 730, is adjusting the temperature of the carbon capture operation. The temperature may be adjusted based on the inferred degradation rates that are measured experimentally. Adjusting the temperature is as previously described in method 600.

Adjusting conditions for the carbon capture operation may include, at block 740, adjusting a liquid circulation rate. The liquid circulation rate may be adjusted to ensure performance of the system. Adjusting the liquid circulation rate is as previously described in method 600.

Adjusting conditions for the carbon capture operation may include, at block 750, modifying the composition of the carbon capture solution. The composition may be modified by the addition of solvent, removal of degraded solvent, addition or removal of water from the solution, or addition of additives, such as degradation inhibitors, corrosion inhibitors, or caustic. Modifying the composition of the carbon capture solution is as previously described in method 600.

After adjusting the carbon capture operation, the example method 700 includes returning to, at block 710, monitoring the mass spectrometry system response of a sample of a solution produced by the carbon capture operation. The method 700 may be repeated as necessary to optimize the carbon capture operation.

Embodiments of the present disclosure may provide at least one of the following advantages. The method as disclosed herein may separate the carbon capture solvent and degradation products with an improved resolution over other methods known in the art, allowing for more accurate quantification and qualification of degradation products. In particular, the method disclosed allows for the determination of trace quantities of degradation products in the presence of a solvent matrix which is at several orders of magnitude higher concentration. The method disclosed is without complicated and labor intensive sample derivatization or pre-treatment steps. Additionally, the method as disclosed herein may facilitate identification of trends regarding degradation product formation in carbon capture operations. The method as disclosed may allow countermeasures to be implemented to ensure continued performance of the carbon capture operation, minimal down time, and minimal operating and maintenance costs.

### EXAMPLES

### Example 1

Example 1 is an example of a method for identifying a carbon capture solvent and degradation products from a carbon capture operation by liquid chromatography with mass spectrometry (LC-MS).

LC-MS analysis was performed using a Quadrupole Time-of-Flight (Q-TOF) Mass Spectrometer equipped with electrospray ionization (ESI), and a Zwitterionic HILIC HPLC column. The samples were prepared by diluting with a 1,000×-20,000× dilution factor with mobile phase B (i.e., first solvent). MEA was diluted by 20,000×, while the degradation products were diluted by 10,000×. The masses of each sample and eluent used in the preparation were recorded in order to accurately determine the mass based dilution factor.

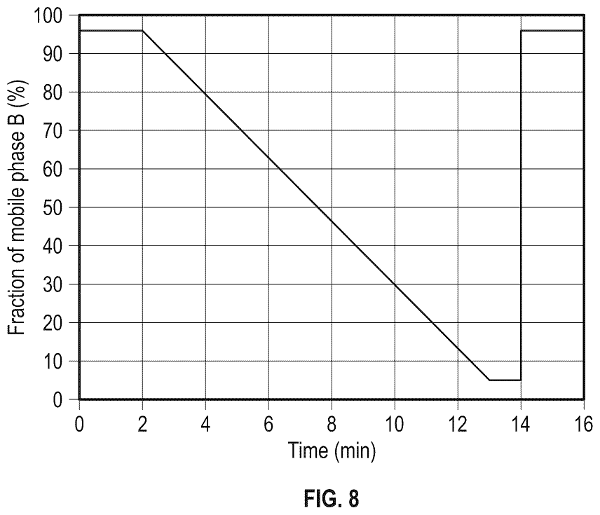

For the LC, a mobile phase was prepared. Mobile phase A (i.e., second phase) was prepared with 0.5 mmol NH₄OH in water. Mobile phase B (i.e., first phase) was prepared with 0.5 mmol NH₄OH and 7% volume water in acetonitrile. The flow rate was 0.3 mL/min. An example gradient for the mobile phase ramping is shown in FIG. 8. The column was an InfinityLab Poroshell 120 HILIC-Z, 2.1×100, 2.7 μm, PEEK-lined column (Agilent). The column temperature was set to 30° C. The injection volume was set to 5 μL by microliter pick-up.

For the MS, the ionization mode for the electrospray ionization was set to positive mode. The mass analyzer was a quadrupole time-of-flight (Q-TOF). The method was optimized for a mass range between 60 amu and 150 amu, however it will still capture higher masses up to 500 amu with less mass accuracy. The scan type was a full scan.

A tuning mix was prepared. The tuning mix consisted of 1-20 mmol of five amines in the mass range of about 60 to 200 g/mol. The compounds were diluted in mobile phase B. The compounds present gave 8 ions which allowed to have a great fit with a high order HPC polynomial. A great fit may be a result of less than 0.05 ppm standard deviation resulting from the fit. The m/z ratio of the eight ions used for the HPC polynomial are listed in Table 2 below.

TABLE 2
m/z Ratio of Ions used for HPC Polynomial

| Charge | m/z |
|---|---|
| 1+ | 140.037591 |
| 1+ | 62.060040 |
| 1+ | 76.039305 |
| 1+ | 126.021941 |
| 1+ | 162.019535 |
| 1+ | 84.041985 |
| 1+ | 98.021249 |
| 1+ | 148.003885 |

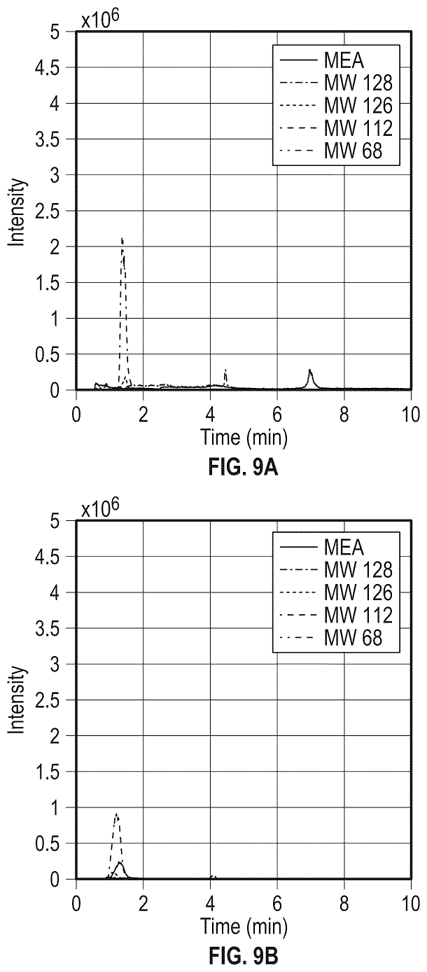

An example extracted ion chromatogram (EIC) from Example 1 of the sample after 72 hours is shown in FIG. 9A. An EIC of the sample measured with a comparative method is shown in FIG. 9B. The comparative method is a known method for use with a Restek Raptor Polar X (2.7 μm, 100 mm×2.1 mm ID) column.

For the comparative method, the column temperature was 35° C. A first phase (mobile phase A) was prepared including water, 0.5% formic acid, and 1 mM ammonium formate, A second phase (mobile phase B) was prepared including a mixture of acetonitrile and water at a 90:10 vol %, 0.05% formic acid, and 1 mM ammonium formate, The flow rate was 0.3 mL/min. The mobile phase was ramped on a gradient as shown in Table 3 below. MS analysis was completed with ESI in positive mode.

TABLE 3
Comparative Method Mobile Phase Gradient

| Time (min) | Vol % Second Phase |
|---|---|
| 0.00 | 96 |
| 2.00 | 96 |
| 10.00 | 30 |
| 10.01 | 5 |
| 11.00 | 5 |
| 11.01 | 96 |
| 13.00 | 96 |

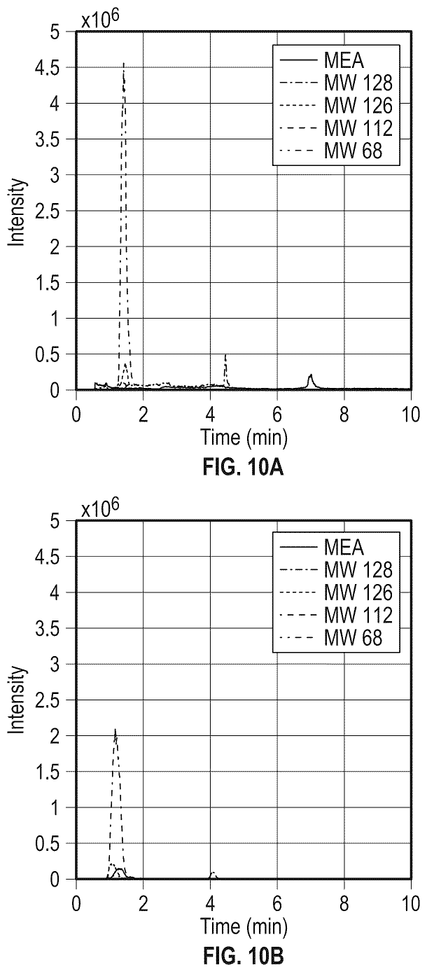

An example EIC from Example 1 of a sample after a 168-hour oxidative stress test is shown in FIG. 10A. An EIC of the sample measured with the comparative method is shown in FIG. 10B. The comparative method for FIG. 10B is the same as the comparative method for FIG. 9B.

The oxidative stress test included batch degradation testing, which was carried out on CO₂-loaded ethanolamine (MEA) and other CO₂ capture solvents. A Parr reactor (100 mL) was heated for seven days at 80° C. and 2 bar total pressure, where the pressure was maintained by feeding pure oxygen to the reactor. A high rate of agitation (1000 rpm) was used to enhance oxygen mass transfer, and metal ions were added to model corrosion in industrial systems. This type of experiment was useful for producing oxidatively degraded samples for analysis and exploring oxidative stability. Oxidative degradation is an important decomposition pathway in real amine scrubbing systems, and degradation rates in this work may be indicative of oxidative stability in real systems.

Resolution values were calculated for the degradation products relative to the observed retention time for MEA based on Equation 8:

$$\frac{{RT}_{1} - {RT}_{2}}{{W}_{0.5 h 1} + {W}_{0.5 h 1}}$$

RT₁ is the retention time of MEA, RT₂ is the retention time of a degradation product, W_{0.5h1} is the width at half-height of the peak for MEA, and W_{0.5h2} is the width at half-height of the peak for a degradation product. The calculated resolution values are shown in Table 4.

TABLE 4

| | Comparative method | | | Inventive Method | | |
|---|---|---|---|---|---|---|
| | RT | W_{0.5 h} | Resolution | RT | W_{0.5 h} | Resolution |
| Compound | (min) | (min) | to MEA | (min) | (min) | to MEA |
| MEA | 1.325 | 0.360 | N/A | 7.014 | 0.138 | N/A |
| MW 128 | 4.095 | 0.159 | 5.337 | 4.471 | 0.051 | 13.455 |
| MW 126 | 1.082 | 0.315 | 0.360 | 1.483 | 0.159 | 18.623 |
| MW 112 | 1.183 | 0.310 | 0.212 | 1.433 | 0.163 | 18.542 |
| MW 68 | 1.174 | 0.369 | 0.207 | 1.399 | 0.226 | 15.426 |

### Example 2

Example 2 is an example of a method for identifying a carbon capture solvent and degradation products from a carbon capture operation by liquid chromatography with mass spectrometry (LC-MS).

Batch degradation testing was carried out on CO₂-loaded ethanolamine (MEA) and other CO₂ capture solvents. A Parr reactor (100 mL) was heated for seven days at 80° C. and 2 bar total pressure, where the pressure was maintained by feeding pure oxygen to the reactor. A high rate of agitation (1000 rpm) was used to enhance oxygen mass transfer, and metal ions were added to model corrosion in industrial systems. This type of experiment was useful for producing oxidatively degraded samples for analysis and exploring oxidative stability. Oxidative degradation is an important decomposition pathway in real amine scrubbing systems, and degradation rates in this work may be indicative of oxidative stability in real systems.

Analysis of the degraded solvents was conducted using a liquid chromatography mass spectrometer (LC-MS) and acid titration on daily aliquots taken from the reactor. The LC-MS was used to quantify amine loss, as well as to identify and quantify degradation products. Solvents and degradation products with separated using a Bruker Elute LC, and monoisotopic masses were determined using a quadrupole time-of-flight MS (Bruker Compact QTOF) and matched to formulas at typically less than 1 ppm mass error.

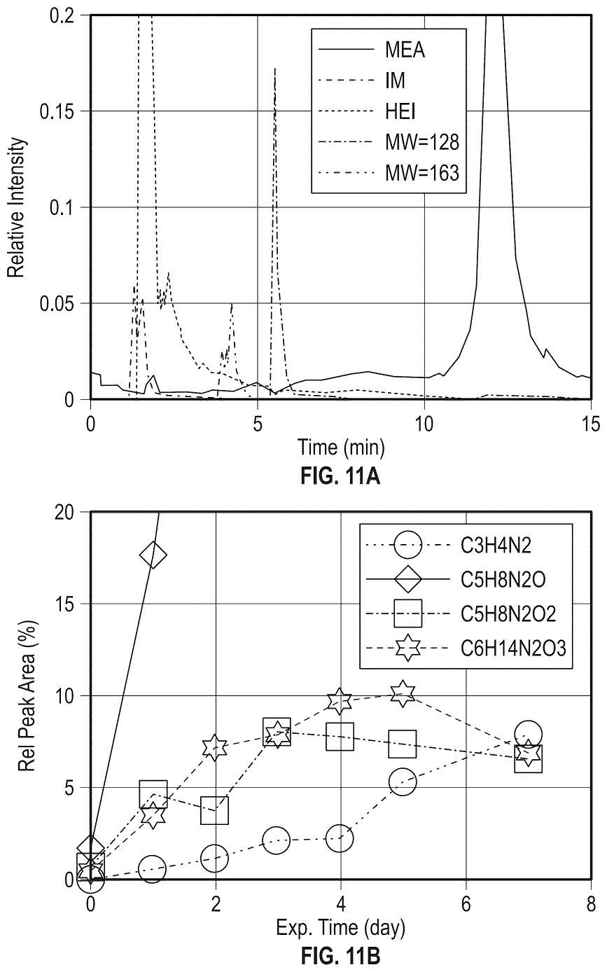

For ethanolamine (MEA), the oxidation rate was around 16 mmol/kg/hr, compared with around 9.5 mmol/kg/hr alkalinity loss. The discrepancy in MEA loss compared with alkalinity loss was likely due to retention of ammonia and presence of other nitrogen-containing degradation products, underscoring the importance of accurate capture solvent analysis and the ability of the analytical method to resolve the capture solvent from other nitrogen-containing and polar constituents. All-in-all 28 degradation product peaks were observed by LC-MS, including 18 unique masses, and 10 isomers which shared the same monoisotopic mass as at least one other product. A product with formula C₅H₈N₂O, thought to be 1-(2-hydroxyethyl)-imidazole (HEI, 112.06482) based on previous work, was by far the most prevalent. Products with formulas C₃H₄N₂ (68.03742), C₅H₈N₂O₂ (128.05852), and C₆H₁₄N₂O₃ (162.10052) were among some of the other more prominent products observed based on integrated mass spec peak area. Most of the degradation products were well-resolved from the MEA peak as shown in the EIC in FIG. 11A, significantly reducing potential interference. Extracted- or single-ion chromatogram peak areas (normalized to HEI, the largest peak area) for suspected products, relative to HEI, are shown in Table 5. The structures shown are hypothesized based on known primary degradation products and degradation mechanisms, as well as previously reported products in literature. The peak area from the EIC may provide a rough indication of molar concentration in the solution, however it is by no means an exact predictor of concentration due to differences in ionization efficiency between compounds. Compounds with greater basicity may more easily accept a proton and thus have a higher ionization efficiency. Compounds with a higher molecular weight may also be more easily ionized and detected. Translating peak area from the EIC into concentration requires calibration with a standard as discussed previously. However, the uncalibrated peak areas may still be useful to indicate general trends and changes in degradation product concentration with respect to time, as well as the rough prominence of some species relative to others, especially when the identity of the compounds is unknown, or no standard is available for calibration.

TABLE 5

| Possible Structure | 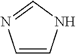 | 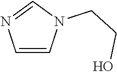 | 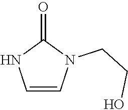 | 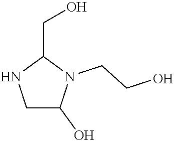 |
|---|---|---|---|---|
| Formula (mass) | C₃H₄N₂ (68.03745) | C [symbol] H [symbol] N₂O (112.06366) | C [symbol] H₈N₂O₃ (128.05858) | C [symbol] H₁₄N₂O₃ (162.10044) |
| Peak Area (%) | 5.3 | 100 | 7.4 | 10.1 |

[symbol]

indicates data missing or illegible when filed

Based on the preponderance of HEI observed in this work, it is hypothesized that some of the products observed may be precursors or derivatives of HEI. For example, in previous work, a mass 162 product has been reported as N-(2-hydroxyethyl)-[(2-hydroxyethyl)-amino]-acetamide (HEHEAA). However, 1-(2-hydroxyethyl)-2-(hydroxymethyl)-imidazolidin-4-ol is one possible alternative candidate for the same monoisotopic mass. Similar analogues are postulated for other formulas identified, such as imidazole (IM) for mass 68 and 1-(2-hydroxyethyl)-imidazolidin-4-ol for mass 128. This hypothesis of HEI precursors is further bolstered by the fact that both the HEI and imidazole peaks increase roughly linearly, whereas masses 128 and 162 begin to flatten out, possibly due to conversion into stable end-product HEI. This is shown in the graph of Relative Peak Area versus Exp. (Expected) Time in FIG. 11B. Mechanistically, it is expected that MEA initially breaks down into ammonia and aldehydes. The aldehydes are reactive towards MEA and can condense into more stable five-membered rings. Importantly, NH₃ is needed for production of HEI, imidazole, and other proposed products. Thus, the experimental setup employed in this work may exacerbate the concentration of these compounds.

### Example 3

Example 3 is an example of a method for identifying a carbon capture solvent and degradation products from a carbon capture operation by liquid chromatography with mass spectrometry (LC-MS).

The method and samples of Example 2 were used. The MW, pKa, polar area, Log P, and RT in minutes (min) are given in Table 6 for ethanolamine (MEA), 1-(2-hydroxyethyl)-imidazole (HEI), imidazole (IM), 1-(2-hydroxyethyl)-1,3-dihydro-2H-imidazol-2-one (HEDHIM), 3-(2-hydroxyethyl)-2-(hydroxymethyl) imidazolidin-4-ol (HEMHIMO), and N-(2-hydroxyethyl)-[(2-hydroxyethyl)-amino]-acetamide (HEHEAA).

TABLE 6

| | MEA | HEI | IM | HEDHIM | HEHMIMO | HEHEAA |
|---|---|---|---|---|---|---|
| MW | 61 | 112 | 68 | 128 | 162 | 162 |
| pKa | 9.16 | 6.78 | 7.18 | — | 8.6 | 7.42 |
| Log P | −1.48 | −0.449 | −0.099 | −0.210 | −0.306 | −2.29 |
| RT | 7.20 | 1.36 | 1.23 | 4.96 | 2.74 | 2.74 |
| (min) | | | | | | |

Table 6 shows that MEA is a highly polar compound. The method as described herein allows MEA to be retained (i.e, have a higher retention time) and be separated from the degradation products, which elute off sooner. Log P (water-octanol partition coefficient) is a good predictor of how much each analyte prefers water relative to organic solvents. Compounds with a higher (less negative) log P will have more affinity for the less polar mobile phase.

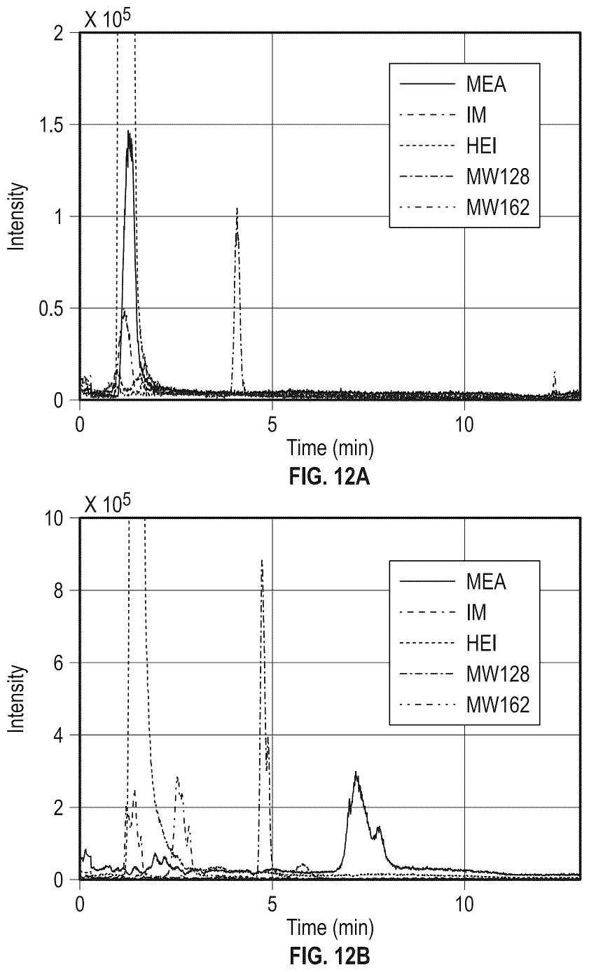

FIG. 12A is an example extracted ion chromogram (EIC) of a comparative method for identifying a carbon capture solvent and degradation products. FIG. 12B is an example EIC for a method for identifying a carbon capture solvent and degradation products, in accordance with one or more embodiments. As seen in FIG. 12B, ethanolamine (MEA) is well retained and separated from the other compounds. As suggested by the properties shown in italics in Table 6, this may be due to the Log P, which is the partition coefficient in the two-phase water/organic solvent system. A lower (more negative) value for Log P indicates a greater preference by the substance for the more non-polar organic phase, compared with the more polar water phase. In HILIC chromatography, compounds with a more negative Log P will generally be retained longer on the polar boundary layer surrounding the stationary phase, resulting in longer retention times.

The fact that Log P is negative for all compounds indicates that they are polar compounds which prefer the first (aqueous) phase (Mobile Phase A), and thus well suited to separation by HILIC liquid chromatography. Log P shows a rough correlation with retention time, with MEA having a more negative Log P, and longer retention time (as shown in bold in Table 6). The results also suggest that HEHMIMO as a more plausible candidate than HEHEAA for the mass 162 peak. Although the two compounds have the same exact mass and formula, HEHMIMO has a less negative Log P than MEA, predicting a shorter retention time, whereas HEHEAA has a more negative Log P, which would suggest a longer retention time than MEA.

Retention may also be strongly affected by other factors such as polar area, molecular weight, and pKa. For alkaline, nitrogen-containing compounds, Log P may be much more negative for the protonated, positively-charged form of the molecule (which may be more abundant at low pH, acidic conditions), whereas for acidic, carboxylate-containing compounds Log P will be more negative for the deprotonated, negatively-charged form, which may be more abundant at high pH. Control of pH through addition of salts with known pKa to the mobile phase eluents is therefore critical for ensuring that all species are in a known form. Considering a sample with various nitrogen-containing moieties, setting the pH of the eluent to a high value of around 10-11 can ensure that all of the species are in a neutral form, and that the separation may therefore correlate with the Log P of each molecule in its neutral state.

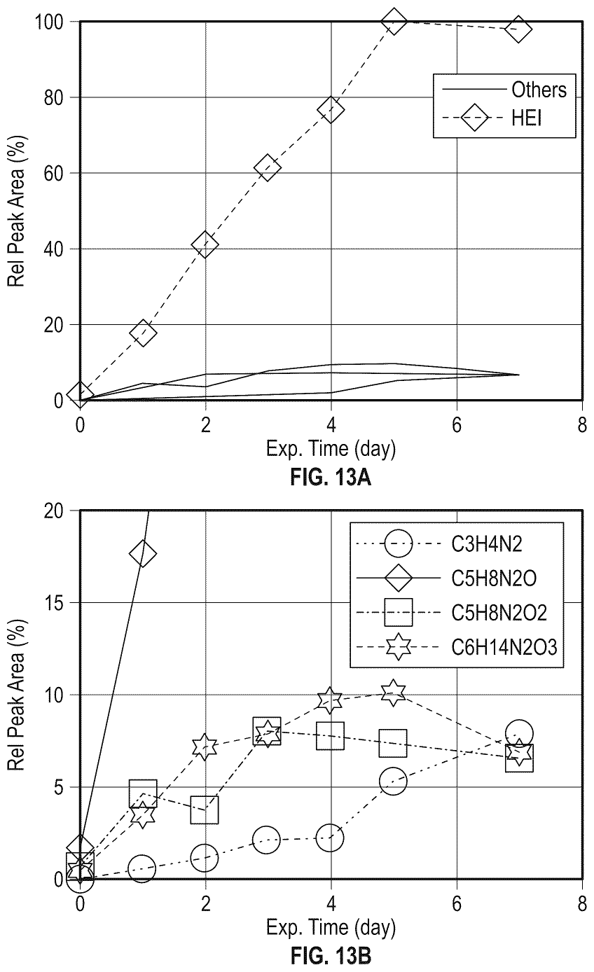

FIGS. 13A and 13B are example graphs of the evolution of the degradation product peaks, in accordance with one or more embodiments. As seen in FIG. 10A, 1-(2-hydroxyethyl)-imidazole (HEI) is the dominant product based on the relative peak area. As seen in FIG. 13B, the products corresponding a mass of 128 g/mol and 162 g/mol which correspond to chemical formulas C₅H₈N₂O₂ and C₆H₁₄N₂O₃ based on their exact mass stop increasing in relative peak area after a period of 3 to 4 days, indicating that they may be intermediate species which begin converting into other products.

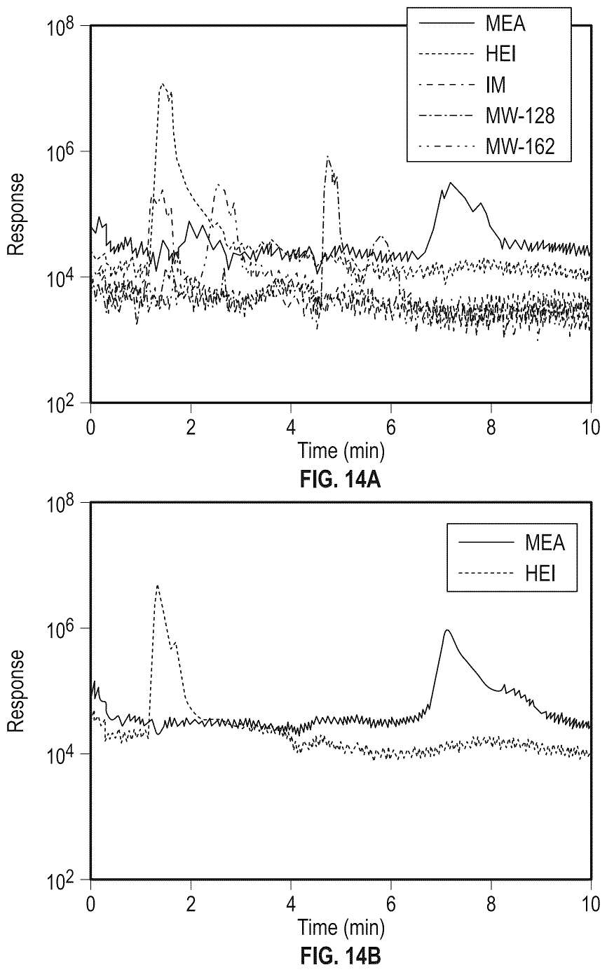

FIGS. 14A and 14B are example chromatograms in accordance with one or more embodiments. FIG. 14A shows the chromatogram obtained with EIC corresponding to a sample of MEA and degradation products such as HEI, imidazole (IM), a compound with a mass of 128 g/mol, and a compound with a mass of 162 g/mol. FIG. 14B shows the chromatogram obtained with EIC corresponding to standards of MEA and HEI. The standard of MEA was diluted to a concentration of about 400 μM. The standard of HEI was diluted to a concentration of about 4 μM. The standards are serial diluted to arrive at the desired concentrations. The first dilution is in deionized water and the second dilution is in the second phase. As shown in FIGS. 14A and 14B, the retention times of the MEA and HEI standards match the retention times of MEA and HEI in the sample of MEA and degradation products. Full factorial combinations of the following variables were conducted prior to generating the EICs. The variables included: a dwell time of 0, 2, or 5 minutes; a ramp rate of 4, 8, or 12 minutes; a starting mobile phase A percentage of 4, 2, or 0%; and a flow rate of 0.2, 0.25, or 0.3 mL/min.

Example 3 shows that the methods according to the embodiments disclosed herein may be used to resolve highly polar amines and degradation products. The LC-MS method parameters have been optimized to achieve high resolution between the carbon capture solvent amine and degradation products. Spectroscopic and chromatographic tools such as those described herein may be complimentary and provide different types of qualitative and quantitative information.

Although only a few example embodiments have been described in detail above, those skilled in the art will readily appreciate that many modifications are possible in the example embodiments without materially departing from this invention. In addition, many modifications will be appreciated by those skilled in the art to adapt a particular instrument, situation, or material to embodiments of the disclosure without departing from the essential scope thereof. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed:

1. A method comprising:
providing a sample of a solution produced by a carbon capture operation, wherein the solution comprises a carbon capture solvent and degradation products of the carbon capture solvent produced by the carbon capture operation;
forming a mobile phase, wherein the mobile phase is buffered to a pH of at least 9, using a buffer system;
diluting the sample via at least one dilution wherein a diluent used in a final dilution is buffered to a pH of at least 9, using the same buffer system used for the mobile phase at a start of the method, and wherein the diluent used in a final dilution has the same composition as the mobile phase at the start of the method;
obtaining fractions of the solution by separating the sample with a hydrophilic interaction liquid chromatography (HILIC) system, wherein the HILIC system comprises a stationary phase and the mobile phase;
measuring substances in the fractions with a detector wherein the detector responds to the carbon capture solvent and degradation products separated in the fractions; and
identifying the carbon capture solvent and degradation products in the solution produced by the carbon capture operation based on a response of the detector as compared to the response of the detector from a set of standards.

2. The method of claim 1, wherein the mobile phase has a concentration gradient resulting from changing an amount of a first phase and a second phase, wherein the first and second phase independently comprise a base, water, and an organic solvent.

3. The method of claim 2, wherein forming the mobile phase comprises changing a concentration of water in the mobile phase from 1 to 10% v/v to 25 to 50% v/v.

4. The method of claim 2, wherein the base is selected from the group consisting of ammonium hydroxide, ammonium bicarbonate, triethylamine, ammonia, ammonium carbonate, sodium hydroxide, sodium carbonate, sodium bicarbonate, sodium borate, potassium hydroxide, potassium carbonate, potassium borate, and potassium bicarbonate.

5. The method of claim 2, wherein the base is independently dissolved in the water of the first and second phase in a concentration ranging from 0.5 to 100 mM.

6. The method of claim 2, wherein the first phase comprises the water in a concentration ranging from 1 to 10% v/v.

7. The method of claim 2, wherein the second phase comprises the water in a concentration ranging from 90 to 99.99% v/v.

8. The method of claim 2, wherein the first phase has a first partition coefficient that is greater than 0.3, the second phase has a second partition coefficient that is less than 0.25, and wherein the first phase is less polar than the second phase.

9. The method of claim 2, wherein the concentration gradient is formed by changing the amount of the first phase and the second phase over a period of time ranging from 2 to 30 minutes.

10. The method of claim 1, wherein the HILIC system further comprises a zwitterionic HILIC column.

11. The method of claim 1, wherein measuring substances in the fractions with the detector comprises the detector selected from the group consisting of a mass spectrometry instrument, an evaporative light-scattering detector, an ionic conductivity detector, an electrochemical detector, a UV-Visible detector, and combinations thereof.

12. The method of claim 11, wherein the mass spectrometry instrument comprises a quadrupole mass analyzer, a time-of-flight mass analyzer, or combinations thereof scanning over a molecular weight ranging from 40 amu to 500 amu.

13. The method of claim 1, further comprising performing extracted ion chromatogram extraction and measuring a concentration of the carbon capture solvent and the degradation products.

14. The method of claim 13, wherein measuring the concentration of the carbon capture solvent and the degradation products results in a precision of less than or equal to 1% variation between repeat measurements and an accuracy of less than or equal to 3% error.

15. The method of claim 1, wherein the HILIC system further comprises a dwell time ranging from 0 to 5 minutes.

16. The method of claim 1, wherein the HILIC system further comprises a flow rate ranging from 0.2 to 0.3 mL/min.

17. The method of claim 1, wherein diluting the sample with the final dilution yields the carbon capture solvent and degradation products at a concentration ranging from 10 to 1000 μM.

18. A method comprising:
providing a sample of a solution produced by a carbon capture operation, wherein the solution comprises a carbon capture solvent and degradation products of the carbon capture solvent produced by the carbon capture operation;
diluting the sample via a serial dilution wherein a diluent of a final dilution is buffered to a pH of at least 9, using a diluent wherein the diluent and a mobile phase use a same buffer system and have the same composition, and wherein the dilution is sufficient to ensure the carbon capture solvent and degradation products are in a pre-determined range for analysis and detection by a hydrophilic interaction liquid chromatography (HILIC) system coupled with a detector;
calibrating the detector with a tuning mix comprising compounds with chemical structure similarities to the carbon capture solvent and degradation products;
obtaining fractions of the solution by separating the sample with the HILIC system, wherein the HILIC system comprises a stationary phase and the mobile phase;
identifying the carbon capture solvent and degradation products in the solution produced by the carbon capture operation based on matching a retention time with a retention time of a set of standards;
verifying an identity by matching properties measured by the detector of the sample compared to the set of standards wherein the properties are selected from the group consisting of a molecular weight, a mass spectrum, an UV spectrum, an amount of light scattered, a conductivity, or an electrical signal; and
measuring the fractions to determine a concentration of the carbon capture solvent and the degradation products using extracted ion chromatogram extraction.

19. A method for management of a carbon capture operation comprising:
monitoring a mass spectrometry instrument response of a sample of a solution produced by the carbon capture operation, wherein the solution comprises a carbon capture solvent and degradation products of the carbon capture solvent produced by the carbon capture operation by performing the method of claim 1; and
adjusting conditions for the carbon capture operation based on the mass spectrometry response for the carbon capture solvent and the degradation products.

20. A method of claim 19, wherein adjusting conditions for the carbon capture operation comprises adjusting a temperature, adjusting a pressure, adjusting a carbon capture solvent flow rate, adjusting a solution composition, or combinations thereof.
